(19) United States
(12) Patent Application Publication
(10) Pub. No.: US 2018/0110673 A1
(43) Pub. Date: Apr. 26, 2018

(54) Anchored Self-Treating Trigger Point Apparatus

(71) Applicant: Nicole Marie Davis, Chicago, IL (US)

(72) Inventor: Nicole Marie Davis, Chicago, IL (US)

(21) Appl. No.: 15/334,299

(22) Filed: Oct. 26, 2016

(51) Int. Cl. A61H 7/00

(52) U.S. Cl. CPC A61H 7/002

(57) ABSTRACT

An anchored yet portable self-treating trigger point apparatus which can mount firmly over a doorway or similar surface. This unit has a simple adjustable anchor with three sides, and screw knobs on two opposing sides to fasten it in place. Facing outward from middle of anchor is a unit with four finger-like protuberances of which the recipient would angle against for trigger point relief. The protuberance unit can rotate 360 degrees to provide pressure from any angle.

### PRIOR ART

One invention presenting a similar concept to mine is The Myofascial Rehabilitation Board, patent #6821260. The client is able to position themselves against a supportive unit, however there are some disadvantages. One disadvantage is that the unit is not anchored in place. Also, the client has to lie back on the unit, therefore restricting his/her ability to angle properly. Also restricted is the ability to control pressure. If person is lying on the protuberance, they would be straining muscles in order to ease pressure onto the unit. What is needed is a device that will hold securely in place and provide enough support needed for the pressure the recipient chooses to administer, while also allowing for free range of motion and the ability to relax within their efforts.

Another invention presenting a similar concept to mine is patent #D711,009 which is an ornamental design for a “Wall Mounted Back Massager”. This contraption ideally would provide sturdy support for a recipient to angle against while reserving range of motion, however it is not adjustable or portable. My invention requires no hard install, and can be set at any height along a doorframe to target any area of the body. Since my invention is also adjustable, it also allows for treatment from any angle.

### REFERENCE CITED

US Patent Document

| | | |
|---|---|---|
| 6,821,260 | Nov. 23, 2004 | Fors, Gregory Charles |
| D711,009 | Aug. 12, 2014 | Wong, Allison P. |

### BACKGROUND OF THE INVENTION

The present invention relates to home therapy for pain relief. Many people suffer from pain caused by trigger points, or “knots”. When part of the muscle tissue is deprived fresh oxygenated blood flow, it can trap gas and air, or a “knot” in the tissue. When one has a “knot” it causes strain on all of the muscles' attachments, origins, and insertions. This in consequence has an effect on the skeletal system as well as all other parts of the body. This is a very common ailment, potentially causing tremendous pain and discomfort. Once pressure is applied at precisely the right angle, the knot can release which in turn releases the strained muscle origins and attachments. Even though a trigger point can often be released fairly quickly using precise and accurate pressure, lack of an effective tool has made this challenging to render on one's own posterior. Even if a person has found someone to treat him/her, it is often difficult for the other person to know exactly where the recipient needs pressure, and from which angle to apply. Also, many people cannot afford treatment with a professional.

There are many other kinds of trigger point release mechanisms on the market. Some are hand-held apparatuses, intended to be used by a second party on the person. These can be very effective, yet require a second person willing to administer treatment. There are also many self-treatment devices; however these generally require the recipient to try to hold the device in proper position while also trying to relax, which is essentially futile.

### SUMMARY OF THE INVENTION

The present invention describes a self-treatment apparatus which can provide sturdy support for trigger point release while also being portable and adjustable. The apparatus includes an anchor which can clamp around any doorway (or similar mounting surface) and can be adjusted to any height to provide relief for any section of the body. The device is lightweight and requires no hard install, which also makes it easy to travel with.

The treatment mechanism for the apparatus is a four-protuberance unit which mimics the thumb and forefinger of the left and right hand in stretch treatment position. The base of the protuberance unit can rotate 360 degrees which enables recipient to receive treatment from any angle. In addition to the site specific treatment of trigger points, this unit can also be used to treat muscles in a massage manner, via gliding techniques and cross-fiber friction technique.

The anchor itself suggests the capability of supporting more than one type of therapy mechanism. Some ideas include a rolling ball within a base, or a single knob-like protuberance in a base.

### DESCRIPTION OF THE FIGURES

FIG. 1 is a frontal view of the present invention

FIG. 2 is a top view of the present invention

FIG. 3 is a frontal view of the hand configuration after which the four protuberance mechanism is modeled

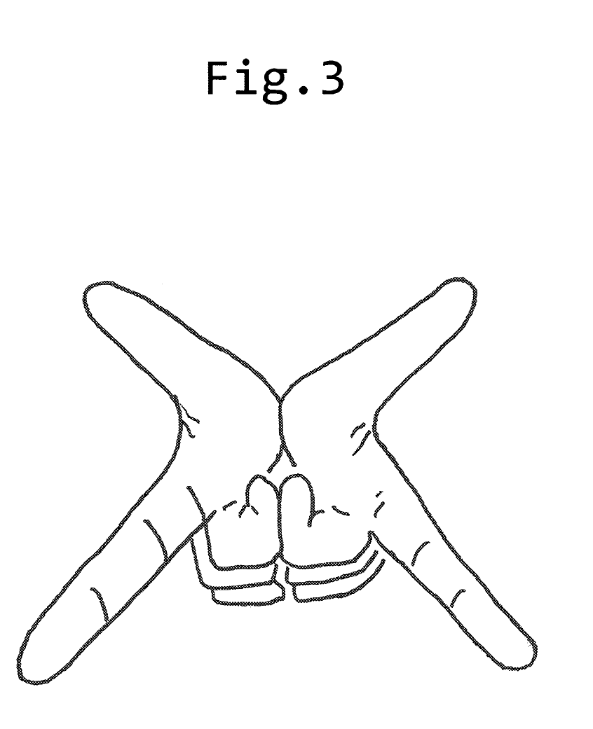

### DETAILED DESCRIPTION

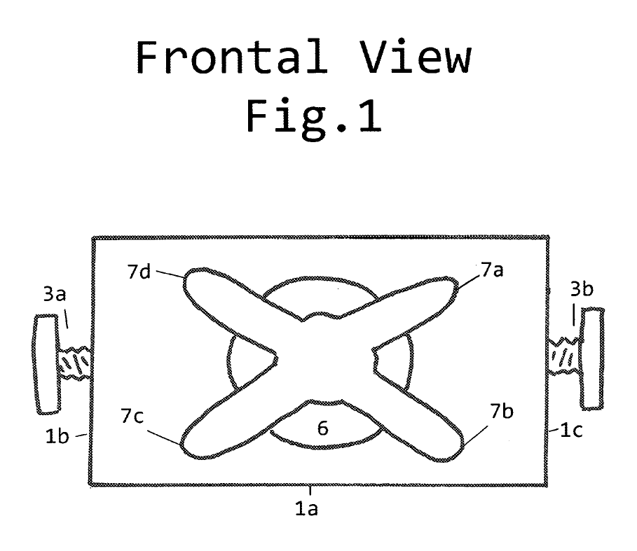

FIG. 1 shows a frontal view of anchor 1a-c, with trigger point release mechanism 6,7a-d in place. Number 1 is the anchor. The sides of the anchor 1b-c fit over a doorway wall or similar surface. The distance between 1b and 1c is approximately 10 inches. The sides 1b-c are approximately 1½″ thick, 6″ long, and 5″ high. Each side 1b,c of the anchor 1a-c has a hole 2a,b through the middle approximately 1½″ in diameter. The fastening units 3a,b screw in through the holes 2a-b. The fastening units 3 a-b stay within the walls of the anchor 1b,c. The front wall of the anchor 1a is approximately 3″ thick and has a bored and threaded hole 5 in center. This hole 5 is approximately 2″ deep and receives the threaded base 6 of the trigger point releasing mechanism 6,7a-d. The base of the mechanism 6 is approximately 3″ in diameter and approximately 2″ deep. Facing outward from the center of the base 6 are four protuberances 7a-d. Protuberances 7a &7d are approximately 3″ long and face outward and down at an approximately 35 degrees angle. Protuberances 7b and 7c are 1¼″ beneath 7a&7d and face outward and down at a slightly steeper angle. Protuberances 7b&c are approximately 3½″ long. Protuberances 7d and 7c simulate the extended thumb and forefinger of a right hand, and protuberances 7a and 7b simulate the extended thumb and forefinger of a left hand. The distance in width between the origin of 7c and 7b is approximately 1½.

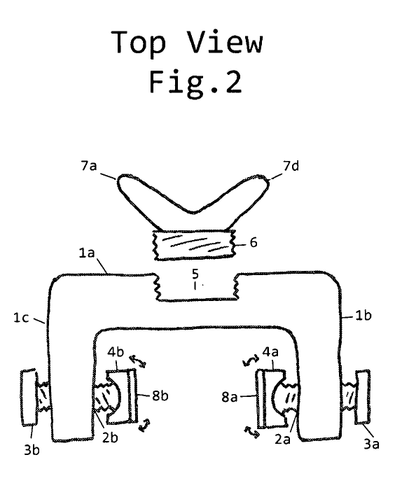

FIG. 2 shows a top view of the contraption, with the trigger point release mechanism 6,7a-d removed. Here you can see the bored and threaded section 5 of the anchor 1a-c. This view also reveals the feet 4a,b of the screw knobs 3a,b and the padding 8a,b of the feet 4a,b. The feet 4a,b are swivel mounts so that they may adjust to mount multiple surfaces. The most obvious are a hallway or a corner. The padding 8a,b is a type of eco conscious foam rubber and is used to protect the mounting surface as well as to add stability via friction. Also seen more in this view are the sides of the anchor 1a,c.

Recipient places the anchor 1a-c around a doorway wall (or similar mounting surface) at the height appropriate for the body part being treated. The next step is tightening the screws 3a,b to fasten anchor 1a-c in place. If the protuberance unit 7a-d needs adjusting the recipient would simply turn base 6 until protuberances 7a-d are projecting at the desired angle. For trigger point relief the recipient positions his/herself against any or all of the protuberance(s) 7a-d. For massage work recipients may choose to use a lubricant on bare skin and maneuver themselves against protuberances 7a-d.

It should be understood that the embodiments as set forth hereinabove are considered in all respects as illustrative only and not restrictive. Especially particulars that are not stated explicitly in the disclosed embodiments, for example, operational procedures, various parameters, and the dimensions, weights, and so forth of constituent components will not depart from the scope of practice customarily made by those skilled in the art, and the aforestated particulars take on values that can easily be presumed by those having ordinary skill in the art.

I claim:

1. An anchored, yet portable and fully adjustable self-treatment apparatus which can be mounted in a doorway and provide firm, immobile support for trigger point release and massage

2. Device in claim 1 wherein trigger point release mechanism simulates the thumb and forefinger of the left and right hand in stretch treatment position

3. Device in claim 2 wherein trigger point release and massage mechanism can rotate 360 degrees to provide relief from any angle

4. Device in claim 1 wherein anchor has swivel mounts allowing it to mount uneven and/or angled surfaces
